(19) United States
(12) Patent Application Publication
(10) Pub. No.: US 2008/0076640 A1
(43) Pub. Date: Mar. 27, 2008

(54) Damping adjusting mechanism for exercise machines

(76) Inventor: Chien-Yu Lin, Taichung (TW)

Correspondence Address: Chien-Yu Lin, 235 Chung-Ho, Box 8-24, Taipei, omitted

(21) Appl. No.: 11/526,910

(22) Filed: Sep. 26, 2006

(51) Int. Cl. A63B 15/02; A63B 21/00; G05G 11/00

(52) U.S. Cl. 482/92; 74/489; 482/1

(57) ABSTRACT

A damping adjusting mechanism for exercise machines comprise's a mount to be connected to an exercise machine, a locking unit mounted on top of the mount having a vertical slot, an adjusting unit inserted into a longitudinal through hole within the locking unit, and a press-on member partly embedded within the vertical slot, wherein it is pivotally attached. The press-on member further includes a plurality of uniformly distributed tooth sections for the engagement with the mount. Thereby, a user can presses the press-on member to drive a pull string that adjusts the spacing between a damping wheel and a magnet belt, achieving damping of various magnitudes.

### FIELD OF THE INVENTION

The present invention relates to damping adjustment for exercise machines, more particularly to a damping adjusting mechanism for exercise machines installed on a handle.

### BACKGROUND OF THE INVENTION

Many exercise machines are equipped with damping mechanisms for producing resistant effect. However, to achieve resistant effects of various degrees, a damping adjusting mechanism is necessary so that a user can twist the string for varying the spacing a set of magnetic plates and the surface of magnetic suction on a damping wheel. Thereby, the magnitude of the resistance when the machine is stepped on can be adjusted to achieve different work strengths.

Although the damping adjusting mechanisms of the prior art is convenient to a user, there is a lack in multi-step locking mechanism, which may cause a change in the resistance of the stepping is too wild. The sudden change in resistance may cause anomalous and harmful shock to the user's knees. Further, it is necessary to exert larger force to twist the conventional dial-type damping adjusting mechanism, which may cause an obstacle to users with smaller waist strength. It is therefore necessary to invent a damping adjusting mechanism with a resistance locking function and which is easy to adjust at the same time.

### SUMMARY OF THE INVENTION

The primary objective of the present invention is to provide a damping adjusting mechanism for exercise machines by which the damping effect can be adjusted easily.

The secondary objective of the present invention is to provide a damping adjusting mechanism for exercise machines having a push-type device for adjusting damping.

To achieve above object, the present invention provides a damping adjusting mechanism for exercise machines, comprising: a mount attached to an exercise machine; a press-on member partly embedded and pivotally mounted within the mount, a bottom face of the press-on member further including a plurality of uniformly distributed tooth sections for engaging the mount, the press-on member further comprising a lateral indication panel so that a user can see through a view window on a corresponding sidewall of the mount to monitor damping condition; and a locking unit mounted on top of the mount having a vertical slot, the locking unit further comprising an adjusting unit inserted into a longitudinal through hole therein and a retaining piece consisting of a rod part and an expanded end, the retaining piece thus being a T-shaped body that can be locked with a retaining tooth, the retaining piece in cooperation with a recoil unit achieving multi-sectional adjustment of damping; whereby the user can presses the press-on member to drive a pull string that adjusts the spacing between a damping wheel and a magnet belt for achieving damping of various degrees.

### BRIEF DESCRIPTION OF THE DRAWINGS

FIG. 1 is an exploded perspective view of a damping adjusting mechanism for exercise machines of the present invention.

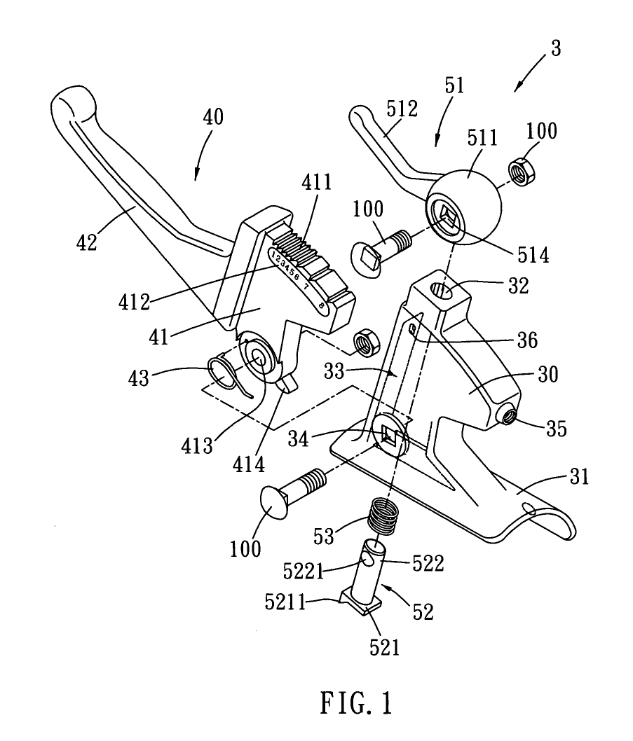

FIG. 2 is a perspective view of the damping adjusting mechanism for; exercise machines in FIG. 1.

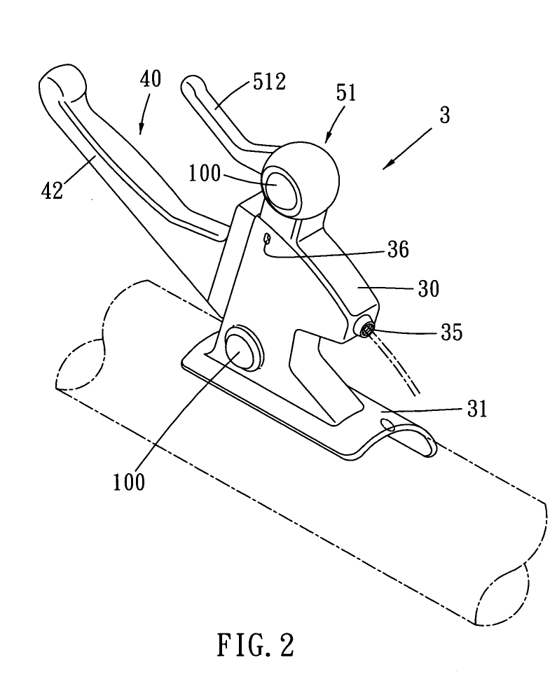

FIG. 3 is a lateral cross-sectional view of the damping adjusting mechanism for exercise machines in FIG. 2.

FIG. 4 shows the configuration of least damped damping adjusting mechanism in FIG. 3.

FIG. 5 shows the configuration of moderately damped damping adjusting mechanism in FIG. 3.

FIG. 6 is a perspective view of the damped damping adjusting mechanism attached to an exercise machine.

FIG. 7 shows another preferred embodiment of the mount associated with the present invention.

FIG. 8 is an exploded perspective view of the damped damping adjusting mechanism attached to an exercise machine.

### DETAILED DESCRIPTION OF THE PREFERRED EMBODIMENTS

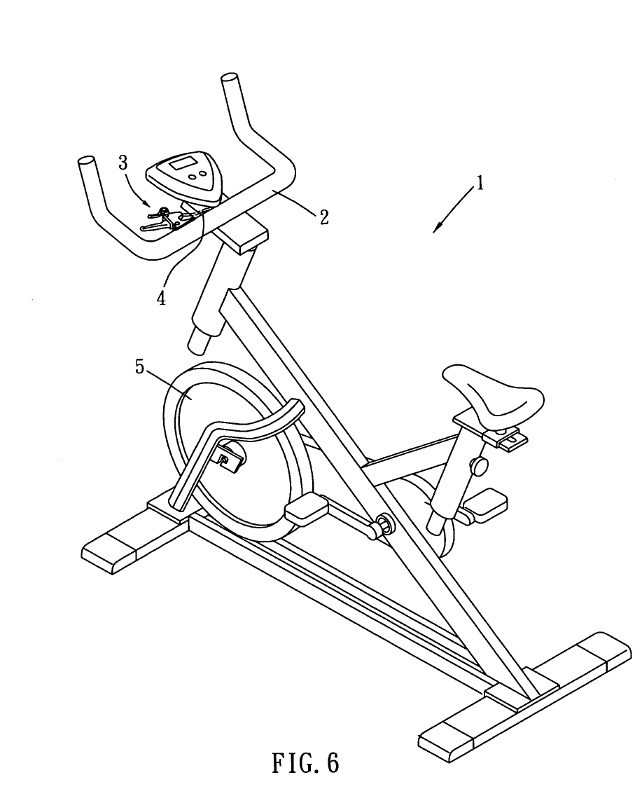

Referring to FIG. 6, a damping adjusting mechanism for exercise machines according to the present invention is mounted on a rod-like handle 2 of an exercise machine 1, which is a damping adjusting mechanism 3 controlling the spacing between a magnetic belt (not shown) and a damping wheel 5 by a string 4. Thereby, the damping coefficient of the damping wheel 5 can be freely adjusted to provide a user with exercises of different strength.

The present invention is an improved damping adjusting mechanism 3 mounted on the handle 2 of the exercise machine 1 comprising a mount 30, a press-on member 40 and a locking unit.

The bottom end of the mount 30 is provided with an engagement surface 31 taking the curved shape. The engagement surface 31 is provided with a through hole 32, and the mount 30 is provided with a slot 33 in a longitudinal direction perpendicular to the through hole 32. Further, the bottom end of the mount 30 adjacent to the slot 33 is provided with a square locking hole 34 passing through the mount 30 and perpendicularly connected to the through hole 32. The end of the slot 33 opposite to the mount 30 is further provided with a string hole 35 connected to the slot 33 for the passage of the string 4. One end of the string 4 is connected to the magnet belt adjacent to the damping wheel 5, and the other end thereof passing thorugh the slot 33 is connected to the press-on member 40 for a user to control the spacing between the magnet belt and the damping wheel. Thereby, a variety of resistant effects can be provided.

The press-on member 40 includes an insertion portion 41 contained in the slot 33 and a press-on handle 42 extended out of the slot 33. There are eight tooth sections 411 distributed along the upper face of the through hole 32, which correspond to the insertion portion 41 in the slot 33. Each of the tooth sections 411 consists of a slope a and a vertical face b. A lateral side of the insertion portion 41 is further provided with a indication panel 412 showing a range of eight damping coefficients. There is a view window 36 on the lateral side of the mount 30 corresponding to the indication panel 412, thereby a user can view the precise damping effect. On the opposite side of the indication panel 412 of the insertion portion 41 there is a pivot hole 413 connected to the locking hole 34 for facilitating the penetration of a pin 100, whereby the press-on member 40 can be pushed downward to engage the mount 30. The restoring of the press-on member 40 is realized by a torsion spring 43 inserted between the pivot hole 413 and the locking hole 34. The bottom of the pivot hole 413 facing forward is obliquely extended with a locking piece 414 that will settle into the V-shaped space 331 within the slot 33 when the press-on member 40 is located at the section of least damping. Thereby, the locking piece 414 can prevent unwanted departure of the press-on member 40 from the mount 30.

The locking unit further comprises an adjusting unit 51 and a retaining piece 52. The adjusting unit 51 further includes a round head 511 disposed on top of the through hole 32 and handle part 512 extended from one end of the round head 511. The round head 511 further includes a longitudinal receptacle 513 on a flat bottom thereof toward the through hole 32 and a transverse through hole 514 perpendicular to the longitudinal receptacle 513.

The retaining piece 52 is T-shaped part consisting of an expanded end 521 and a rod part 522. The retaining piece 52 further comprises a retaining tooth 5211 capable of being engaged with the tooth sections 411. The rod part 522 is encircled by a recoil part 53 and has a through hole 5221 aligned with the transverse through hole 514. The retaining piece 52 will be inserted into the through hole 32 and stopped within the longitudinal receptacle 513 of the round head 511. A pin 100 is inserted into the transverse through hole 514 and the through hole 5221, whereby the locking unit will be stably mounted on the upper opening of the through hole 32.

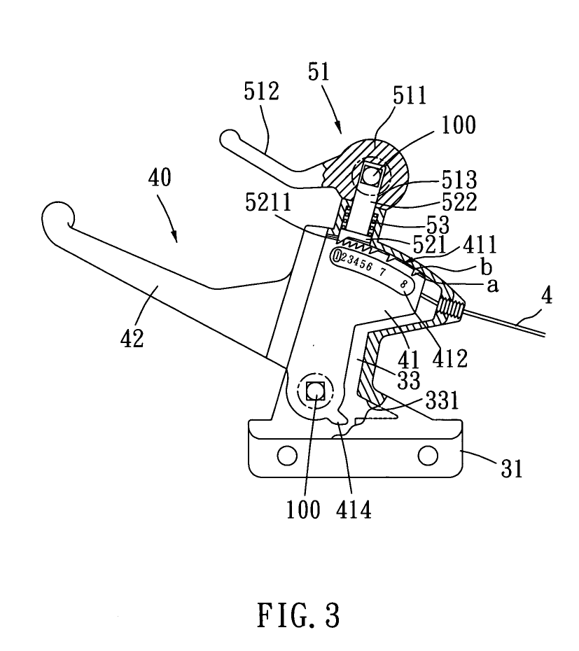

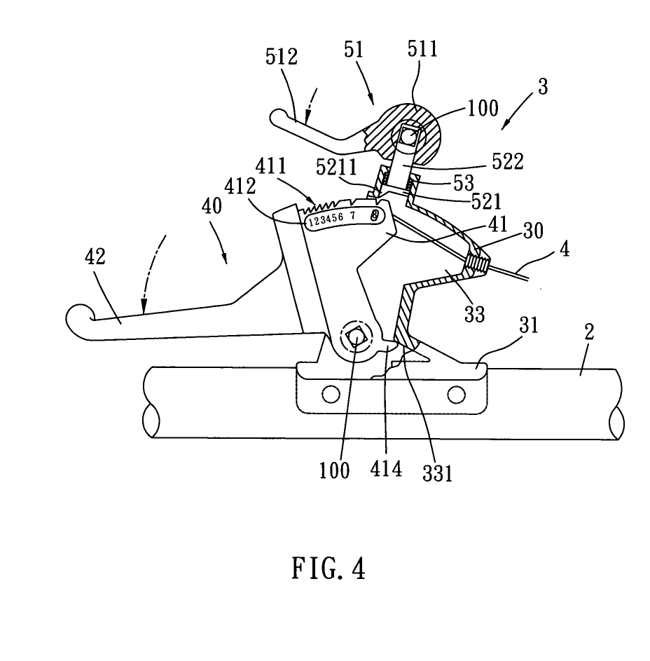

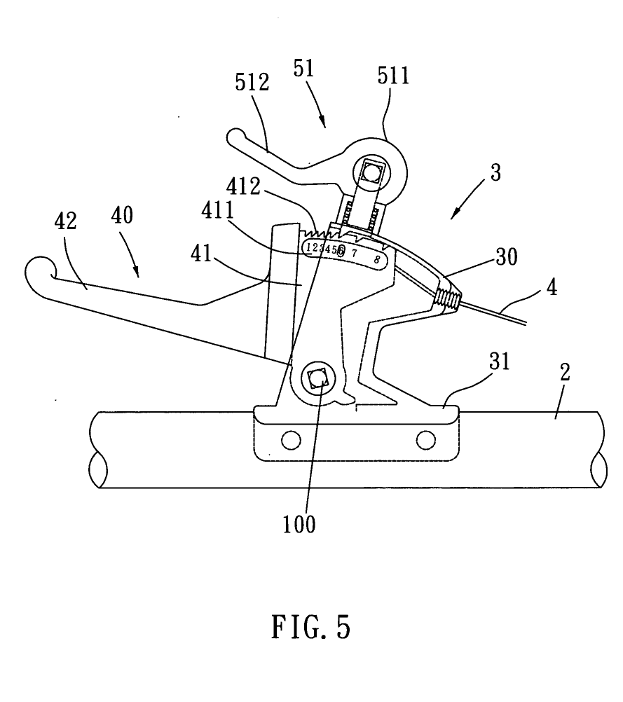

To use the damping adjusting mechanism 3 and show its effects, please refer to FIGS. 3 to 5.

As shown in FIG. 3, the retaining tooth 5211 of the locking unit are in a position corresponding to a tooth section 411 marked by 1; at this moment, the magnet belt and the damping wheel are closest, and therefore the damping effect is maximized. A user needs to exert a strong stepping force to drive the damping wheel. To lower the damping effect to a moderate value, the user does not have to stepping; all he or she has to do is to hold the press-on handle 42 of the press-on member 40 tight, and the press-on member 40 will rotate about the pivotal point, pushing the slopes a of the tooth sections 411 forward over the retaining tooth 5211 till the retaining tooth 5211 falls into a tooth section 411 marked by 6. Thus, the damping adjusting mechanism is easy to operate, and the user can monitor the status of damping through the view window.

It is a further safety measure that when the press-on member 46 is accidentally pushed by the user and the retaining tooth 5211 slides to the tooth section 411 of minimal damping marked by 8, the locking piece 414 will be stopped in the V-shaped space 331 in the slot 33, preventing a departure of the retaining tooth 5211 from the tooth sections 411. Further, when a user wants to change the magnitude of damping from the minimum to the maximum, the retaining tooth 5211 will be blocked by the vertical faces b in the tooth sections 411 unless the twisted torsion spring 43 is activated by the recoil part 53 driven by the handle part 512 of the adjusting unit 51. Therefore, the adjustment of damping can recoil and secure the adjustment quickly.

The vertical faces b in the tooth sections 411 of the present invention provide the retaining tooth 5211 a locking mechanism for preventing a departure of the retaining tooth 5211 from the tooth sections 411 and falling into the tooth section 411 of maximal damping, which will cause a sudden rise of damping resistance that may hurt the user.

More than that, the damping adjusting mechanism 3 of the present invention is different form the devices of the prior art in that the damping is adjusted by a press-on means, which is easy to operate; the press-on member 40 controls the suction force between the damping wheel and the magnet belt through the recoil spring 43 can achieve step-be step damping adjustment.

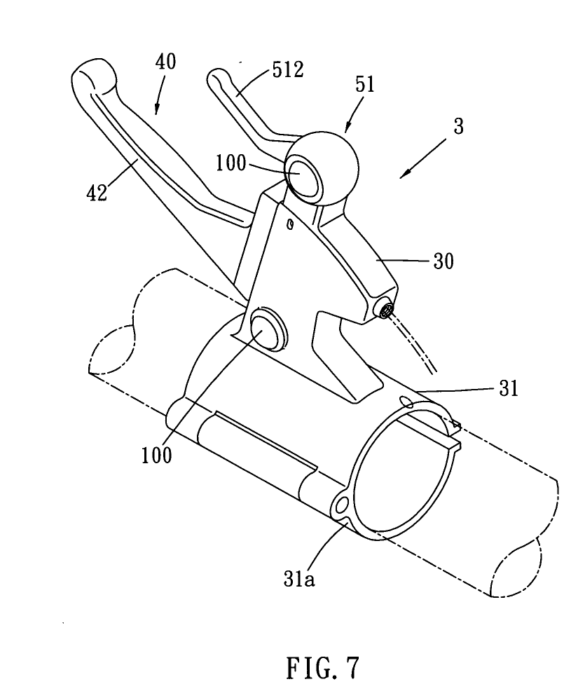

Referring to FIG. 7, except for the connecting mechanism between the engagement surface 31of the mount 30 and the handle 2 by either soldering or screwing, the curved retaining plate 31a taking the shape of hollow cylinder can be applied to provide a connecting mechanism between the mount 30 and the handle 2.

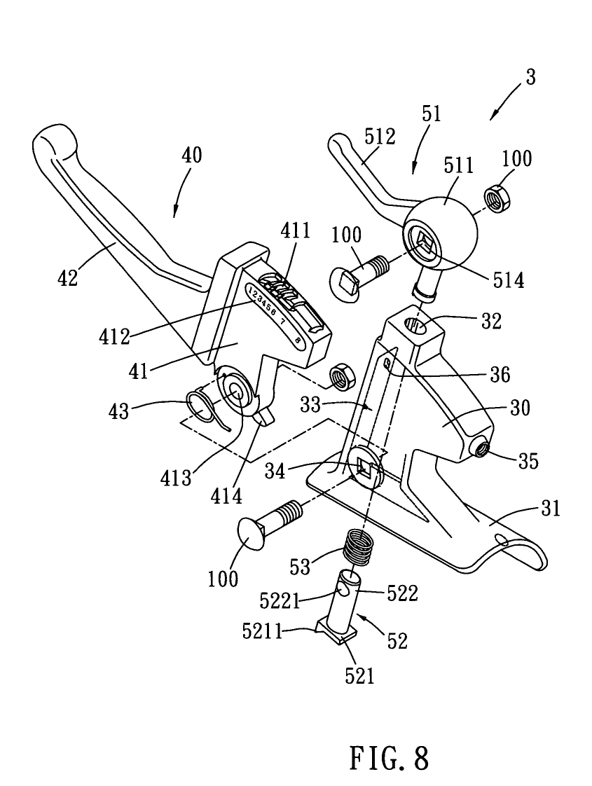

Referring to FIG. 8, the tooth sections 411 of the damping adjusting mechanism 3 are transformed into a left groove and a right groove, whereby the retaining tooth 5211 will recoil for a single step when the adjusting unit 51 is pressed, which can prevent a sudden surge of damping resistance due to improper operation.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A damping adjusting mechanism for exercise machines, comprising:
a mount attached to an exercise machine;
a press-on member partly embedded and pivotally mounted within said mount, a bottom face of said press-on member further including a plurality of uniformly distributed tooth sections for engaging said mount, said press-on member further comprising a lateral indication panel so that a user can see through a view window on a corresponding sidewall of said mount to monitor damping condition; and
a locking unit mounted on top of said mount having a vertical slot, said locking unit further comprising an adjusting unit inserted into a longitudinal through hole therein and a retaining piece consisting of a rod part and an expanded end, said retaining piece thus being a T-shaped body that can be locked with a retaining tooth, said retaining piece in cooperation with a recoil unit achieving multi-sectional adjustment of damping;
whereby said user can presses said press-on member to drive a pull string that adjusts the spacing between a damping wheel and a magnet belt for achieving damping of various degrees.

2. The damping adjusting mechanism for exercise machines of claim 1 wherein a torsion spring is installed between said press-on member and said mount for recoiling said press-on member backward.

3. The damping adjusting mechanism for exercise machines of claim 1 wherein said press-on member is further provided with a locking piece at a location adjacent to said pivotal portion thereof, whereby said locking piece will be locked in a V-shaped space when said press-on member is located at said tooth section of minimal damping.

4. The damping adjusting mechanism for exercise machines of claim 2 wherein said press-on member is further provided with a locking piece at a location adjacent to said pivotal portion thereof, whereby said locking piece will be locked in a V-shaped space when said press-on member is located at said tooth section of minimal damping.

5. The damping adjusting mechanism for exercise machines of claim 1 wherein a string hole connected to said slot is formed at a predetermined location on said mount, whereby said pull string going through said string hole will be connected to said press-on member for varying the damping condition between said damping wheel and said magnet belt.

6. The damping adjusting mechanism for exercise machines of claim 2 wherein a string hole connected to said slot is formed at a predetermined location on said mount, whereby said pull string going through said string hole will be connected to said press-on member for varying the damping condition between said damping wheel and said magnet belt.

7. The damping adjusting mechanism for exercise machines of claim 1 wherein said engagement portion of said mount is a single curved plate fitting a rod-like handle of said exercise machine attached on said handle by a means selected from welding and screwing.

8. The damping adjusting mechanism for exercise machines of claim 1 wherein said engagement portion of said mount is a hollow cylindrical body consisting of an upper curved plate and a lower curved plate connected to said upper curved plate by a screwing means when said engagement portion is attached on said handle.

9. The damping adjusting mechanism for exercise machines of claim 1 wherein said tooth sections of said press-on member are transformed into a left groove and a right groove, whereby said retaining tooth will recoil for a single step when said adjusting unit is pressed once; thus, which a sudden surge of damping resistance due to improper operation can be prevented.
